(19) United States
(12) Patent Application Publication
(10) Pub. No.: US 2002/0120636 A1
(43) Pub. Date: Aug. 29, 2002

(54) Data management system, data management method and computer program

(76) Inventors: Takashi Ishizaka, Tokyo (JP); Kyoko Suga, Funabashi-shi (JP)

Correspondence Address: Gregory P. LaPointe, BACHMAN & LaPOINTE, P.C., Suite 1201, 900 Chaple Street, New Haven, CT, 06510-2802, US

(21) Appl. No.: 10/082,624

(22) Filed: Feb. 22, 2002

(30) Foreign Application Priority Data
Feb. 23, 2001 (JP) 2001-047730

(51) Int. Cl. G06F 12/00

(52) U.S. Cl. 707/200

(57) ABSTRACT

The data management system includes: a retrieval instructing/displaying mechanism for accepting various retrieval conditions for data storage means in which data belonging to any of multiple managed objects are stored; retrieval part for retrieving data adapted to each of the accepted retrieval conditions from the data storage means and specifying a managed object to which the retrieved data belong; and a collection storage part for holding identification information for identifying the managed object specified by the retrieval part as part of a collection of retrieval results collected for each retrieval condition. In this configuration, the collection held in the collection storage part is set as a target of retrieval instead of the data storage means.

### CROSS-REFERENCE TO RELATED APPLICATIONS

This application is based upon and claims the benefit of priority from the prior Japanese Patent Application No. 2001-047730, filed Feb. 23, 2001, the entire contents of which are incorporated herein by reference.

### BACKGROUND OF THE INVENTION

1. Field of the Invention

The present invention relates to a data management system, and particularly to a data management method capable of integrally handling retrieval results of data distributively stored in multiple databases or data warehouses or existing data externally created.

2. Description of the Related Art

As a typical form of systems for management of data, there is a database management system (DBMS) which performs retrieval and the like of data to be targeted. In many cases, data managed in such a DBMS are distributively stored in multiple databases or other storage means. When data is retrieved across the multiple databases, that is, when so-called compound retrieval is performed, the existing multiple databases and the like need to be so configured that they can be logically handled as one database, or all the distributed data need to be so integrated that they can be retrieved from the multiple databases and the like.

Handling multiple databases or data warehouses logically as one database, however, is accompanied by configurational constrains, depending on the types or versions of the databases and the like. For this reason, it is virtually impossible to handle all the types or versions of databases and the like as one database.

In another form of data management, data retrieval is performed through the mediation of an operator, rather than direct retrieval of data stored in the databases and the like, to list the retrieval results obtained. A significant number of such lists exist in the actual world, and the retrieval is required to narrow down the lists on the basis of retrieval conditions for any other database, compare existing lists, extract data common to both lists, or extract data existing in one list alone.

To realize such requirements on the DBMS, some items for use in managing data contained in the lists need to be created in the DBMS. It is desirable to automatically create such items through the retrieval of data, but depending on retrieval conditions, a complicated retrieval formula may be needed, or there may be no suitable retrieval formula, which makes it virtually difficult to automate the creation of the items.

### SUMMARY OF THE INVENTION

It is an object of the present invention to provide an improved data management technique capable of performing efficient compound retrieval without being restrained by the arrangement, types or existence forms of data storage means in which target data exist.

It is another object of the present invention to enable the above-mentioned data management technique to integrally handle results of compound retrieval and existing data externally created.

In attaining the above-mentioned objects and according to the present invention, there are provided a data management system, a computer-based data management method and a computer program.

In one aspect of the present invention, a data management system comprises acceptance means for accepting various retrieval conditions for data storage means in which data belonging to any of multiple managed objects are stored; retrieval means for retrieving data adapted to each of the accepted retrieval conditions from the data storage means and specifying a managed object to which the retrieved data belong; and holding means for holding identification information for identifying the managed object specified by the retrieval means as part of a collection of retrieval results collected for each retrieval condition, in which the collection held in the holding means is set as a target of retrieval instead of the data storage means.

According to the present invention, since the collection is set as a target of the retrieval instead of the data storage means, when the same retrieval results are expected, a desired set of retrieval results can be made available quickly by reading the collection from the holding means without performing re-retrieval from the data storage means. In this case, there is less load of processing to the system than the case where re-retrieval is performed.

The identification information is to specify a managed object. If data related to customer's goods purchase are to be managed in the data management system, the managed objects will include customers, stores, business contacts, goods, etc.

The above-mentioned data management system may also comprise external data taking-in means for taking in data created in an external system and containing identification information on the managed object to add the identification information contained in the taken-in data as part of a corresponding collection.

Such external data taking-in means may be configured to take in the data created in the external system in the form of a list for each managed object to add the identification information to the collection on a list basis. Thus the data management system can integrally handle the results of retrieval and the existing data externally created.

The above-mentioned data management system may further comprise computation means for performing a logical operation between two or more collections to create a new collection so as to make the holding means hold the newly created collection. In this configuration, the extraction or the like of data common to the collections can be made possible.

The holding means may include temporary storage means for temporarily storing the collections before held therein. In this case, the computation means performs the logical operation between the collections stored in the temporary storage means while storing the new collection in the temporary storage means.

Furthermore, the above-mentioned data management system may comprise modification means for modifying the collections stored in the temporary storage means, which makes it possible to modify the identification information contained in the collections in the form as intended by an operator.

In another aspect of the present invention, there is provided another data management system comprising: acceptance means for accepting various retrieval conditions for a plurality of data storage means in which plural kinds of customer data identifiable by each ID are distributively stored; retrieval means for retrieving data adapted to each of the accepted retrieval conditions from any one of the data storage means and specifying a customer ID of the data retrieved; holding means for holding the ID specified by the retrieval means as part of a collection of retrieval results collected for each retrieval condition; and means for taking in customer-related data created in an external system and containing the ID to add the ID contained in the taken-in data as part of the collection held in the holding means, in which the collection held in the holding means is set as a target of retrieval instead of the plurality of data storage means.

The above-mentioned data management system may also comprise computation means for performing a logical operation between two or more collections to create a new collection so as to make the holding means hold the newly created collection.

In still another aspect of the present invention, there is provided a computer-based data management method implemented on a computer connected to data storage means in which data belonging to any of multiple managed objects are stored, the data management method comprising the steps of: accepting various retrieval conditions; retrieving data adapted to each of the accepted retrieval conditions from the data storage means and specifying a managed object to which the retrieved data belong; and holding identification information for identifying the specified managed object in certain holding means as part of a collection of retrieval results collected for each retrieval condition, in which the collection held in the holding means is set as a target of retrieval instead of the data storage means.

In yet another aspect of the present invention, there is provided a computer program which enables data retrieval on a computer connected to data storage means in which data belonging to any of multiple managed objects are stored, the computer program comprising the steps of: accepting various retrieval conditions; retrieving data adapted to each of the accepted retrieval conditions from the data storage means and specifying a managed object to which the retrieved data belong; and holding identification information for identifying the specified managed object in certain holding means as part of a collection of retrieval results collected for each retrieval condition, in which the collection held in the holding means is set as a target of retrieval instead of the data storage means.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out in the appended claims.

### BRIEF DESCRIPTION OF THE DRAWINGS

These objects and other objects and advantages of the present invention will become more apparent upon reading of the following detailed description and the accompanying drawings in which:

FIG. 1 is a block diagram showing a configuration of a data management system to which the present invention is applied;

FIG. 2 is a table showing the contents of a customer table;

FIG. 3 is a table showing the contents of a purchase history table;

FIG. 4 is a table showing the contents of a set of data table;

FIG. 5 is a table showing the contents of a customer list;

FIG. 6 is a flowchart showing the flow of processing when retrieval is requested;

FIG. 7 is a flowchart showing the flow of processing related to the storage of a set;

FIG. 8 is a flowchart showing the flow of processing related to the reading of the set stored;

FIG. 9 is a flowchart showing the flow of processing for performing a computation between sets;

FIG. 10 is a flowchart showing the flow of processing for modifying a set; and

FIG. 11 is a flowchart showing the flow of processing for creating a set from a customer list taken in from the outside.

### DESCRIPTION OF THE PREFERRED EMBODIMENTS

The following section will describe an embodiment in which the present invention is applied to a data management system for managing data related to customer's goods purchase.

<System Configuration>

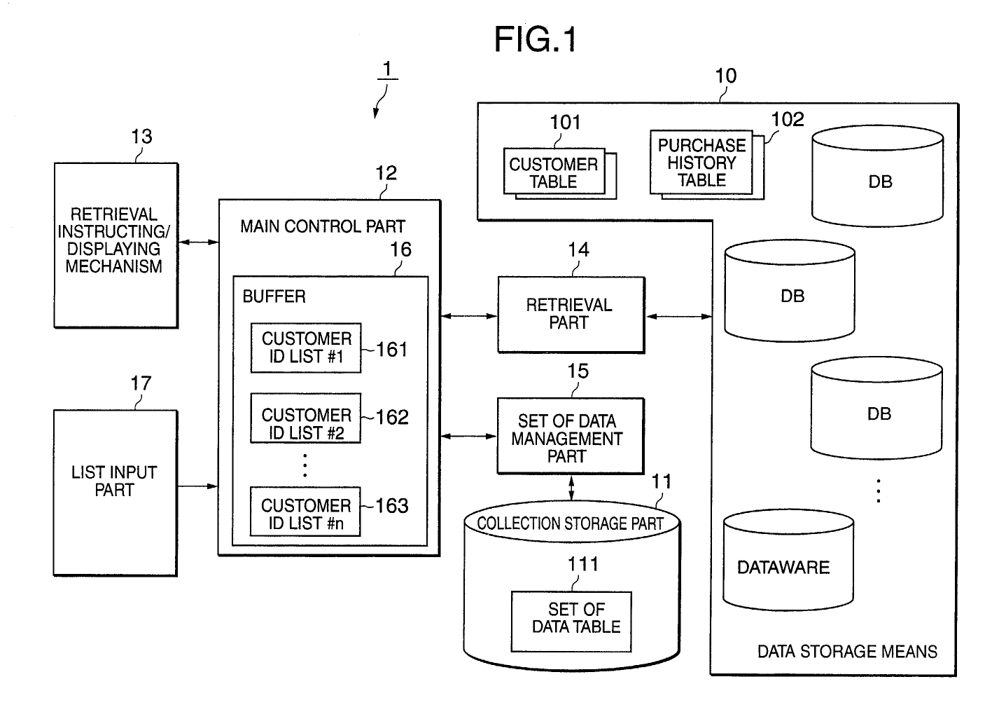

FIG. 1 is a block diagram showing a configuration of a data management system according to the embodiment of the present invention. The data management system 1 is a computer system with communication capabilities, which is connected to data storage means 10 and a collection storage part 11, and is provided with a main control part 12, a retrieval instructing/displaying mechanism 13, a retrieval part 14, a set of data management part 15 and a list input part 17.

The data storage means 10 is composed of multiple databases or plural pieces of dataware which distributively exist. The physical design or interface of each database may vary from database to database as long as the main control part 12 prepares a connection interface with each database.

The data storage means 10 stores therein various attribute data indicative of attributes of each customer, for example, in the form of a table. In the embodiment, a customer table 101 for storing personal information on each individual customer and a purchase history table 102 for storing a history of goods purchase by each customer are stored in databases or plural pieces of dataware, respectively. These tables may be stored in one database or the like or in different databases and the like.

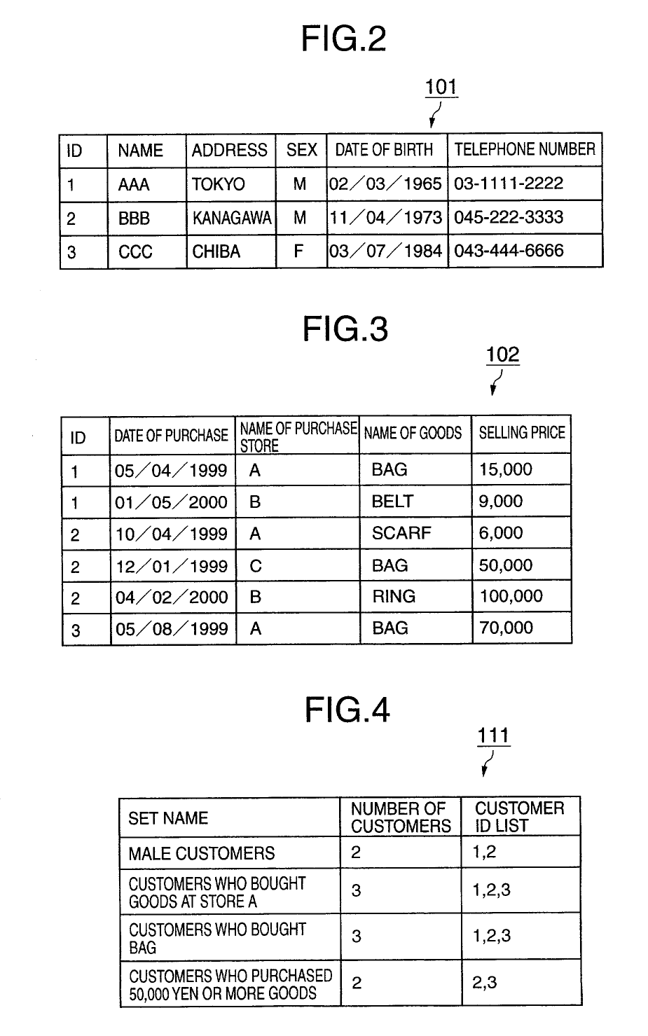

The customer table 101 stores therein personal information exemplified in FIG. 2, that is, the name (title), address, sex, date of birth and telephone number of each customer. The personal information can be uniquely specified by an ID (Identification) as identification information on the customer. An ID is uniquely assigned to each customer. Use of a numerical value as the ID would be necessarily sufficient to manage customers because 4 bytes (32 bits) of numerical values can prepare IDs for 4 billion people.

The purchase history table 102 stores therein data related to goods which each customer has purchased in the past, that is, the name of goods, date of purchase, name of a store in which the goods were purchased, and selling price (purchase price) as shown in FIG. 3. For each item of the purchase history table 102, an ID identical to the ID used in the customer table 101 is used. In the purchase history table 102, one record exists for one event indicative of the fact that a customer bought a piece of merchandise. If one customer has bought goods plural times, records corresponding to the number of purchase times will exist with the same ID. Therefore, if an ID is specified, since the customer table 101 can be referred to by the ID, it can be determined what customer the record in question belongs to.

Thus the use of common IDs will be a necessary condition for the customer table 101 and the goods purchase history table 102 even if the structure is different between databases. The use of common IDs makes it possible to specify the same customer across different databases.

The collection storage part 11 stores therein attribute data on a retrieved customer as a collection of results of retrieval based on each retrieval condition. The collection storage part 11 includes a set of data table 111 which holds the stored contents in the form of a table. In the embodiment, the customer IDs to which data adapted to each of retrieval conditions belong are stored as a collection. Many kinds of “collections” can be assumed, such as a collection of male customers, of customers who bought goods at store A, of customers who bought a bag, or of customers who purchased 50,000 yen or more goods.

FIG. 4 shows the contents of the set of data table 111. In the example of FIG. 4, for the collection of “male customers,” data on two customers are stored in a customer ID list (a list of IDs attached to respective customers corresponding to the retrieval condition, which is the same below) as “1 (corresponding to the name “AAA”)” and “2 (corresponding to the name “BBB”)”. Similarly, for the collections of “customers who bought goods at store A” and “customers who bought a bag,” data on three customers are stored in the customer ID list as “1 (corresponding to the name “AAA”)”, “2 (corresponding to the name “BBB”)” and “3 (corresponding to the name “CCC”)”. For the collection of “customers who purchased 50,000 yen or more goods”, data on two customers are stored in the ID list as “2 (corresponding to the name “BBB”)” and “3 (corresponding to the name “CCC”)”.

The main control part 12 controls the processing operation of the entire data management system 1.

For example, during data retrieval, the main control part 12 analyzes the contents of a retrieval request entered through the retrieval instructing/displaying mechanism 13 to selectively activate the retrieval part 14, the set of data management part 15 and/or the list input part 17 as required. Further, the main control part 12 performs computations (including computations for modification) of customer ID lists obtained from the retrieval part 14, the set of data management part 15 and/or the list input part 17 to store the computation results (including modification results) in the set of data table 111 through the set of data management part 15.

The main control part 12 includes a buffer 16 for temporarily storing data on the number of customers and one or more customer ID lists obtained as a result of retrieval or the like. Each customer ID list is identified by each set name. In this case, a customer ID list the set name of which is given from the outside is identified by the set name. On the other hand, a customer ID list for which no set name is given yet is automatically assigned a set name by the main control part 12 so that the set name will uniquely identify the customer ID list in the system.

The retrieval instructing/displaying mechanism 13 accepts various retrieval instructions from the operator in the system, from another system or a program to send the retrieval instructions to the main control part 12. The retrieval instructing/displaying mechanism 13 also displays the results of processing by the main control part 12 on a display, not shown, and transfers the instructions to the request source. In other words, the retrieval instructing/displaying mechanism 13 functions as an input/output mechanism of the data management system 1. Especially, the embodiment also has the retrieval instructing/displaying mechanism 13 function as a mechanism for accepting an instruction to create a customer ID list (hereinafter called “customer ID list creating instruction”) based on a list taken in from the outside.

The retrieval part 14 performs the retrieval of data from the databases (customer table 101 and purchase history table 102) existing in the data storage means 10 under the control of the main control part 12 to send the main control part 12 the results of retrieval obtained. The retrieval procedure and the like are instructed by the main control part 12.

The set of data management part 15 manages the set of data table 111 under the control of the main control part 12.

To be more specific, the set of data management part 15 stores in the set of data table 111 data on the number of customers and customer lists held in the buffer 16 of the main control part 12, while it reads the data on the number of customers and the customer ID lists stored in the set of data table 111 to send the same to the main control part 12.

The list input part 17 accepts, as a set of data related to customers, a customer list created by an external spreadsheet tool or the like under the control of the main control part 12 to create from the customer list a customer ID list to be handled in the system. Then the list input part 17 inputs to the main control part 12 the customer ID list created.

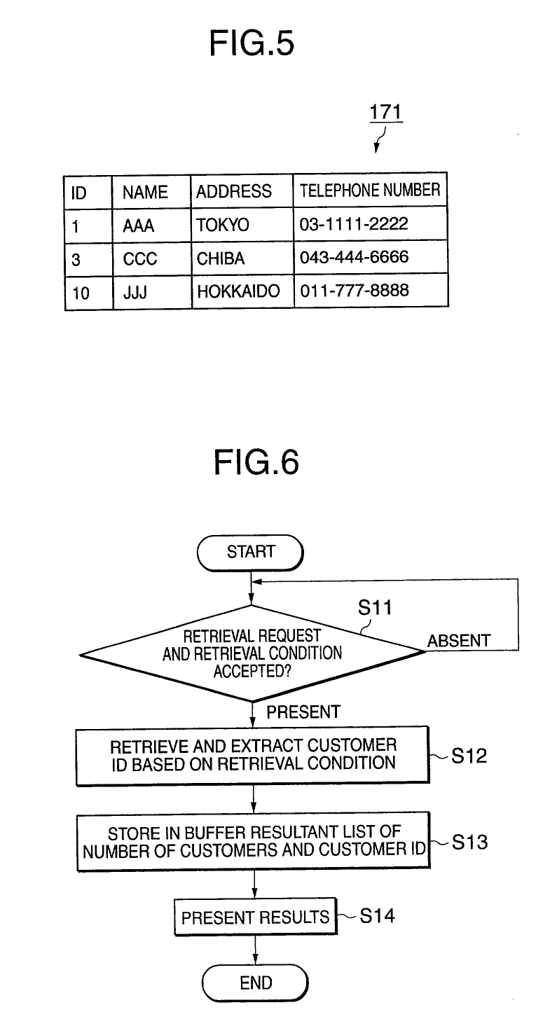

FIG. 5 shows an example of a customer list. For each item of the customer list 171 of FIG. 5, an ID identical to the ID used in the customer table 101 is used. As the other items, items for customer name, address and telephone number are provided. The customer ID list can be created by extracting the ID item from the customer list 171.

<Operation>

Next, description will be made about the contents of the operation of the data management system 1 configured such above.

The following description will be divided into six parts: retrieval of data from the customer table 101 and/or the purchase history table 102 stored in the database or databases of the data storage means 10; storage of retrieval results into the collection storage part 11; reading of the retrieval results stored in the collection storage part 11; logical operation between two or more customer ID lists; modification of a customer ID list; and input of the customer list 171 from the outside.

<Data Retrieval: FIG. 6>

FIG. 6 shows a data retrieval procedure in the data management system 1. The data retrieval is initiated when a retrieval request and a retrieval condition are accepted. It is assumed here that retrieval of data on “customers who bought a bag” is requested.

Upon receipt of the retrieval request and retrieval condition, the main control part 12 specifies in what database the table to be searched exists.

The specification of a database may be performed by two methods: one is to directly specify a database according to the retrieval request and retrieval condition, and the other is to specify a searchable table. In the former case, an interface to be connected to the database specified is selected to specify a table in the specified database through the interface selected so that data will be retrieved from the table specified. In the latter case, a database containing a searchable table is automatically selected to determine an interface for connecting the database selected. Thus the specified table can be searched.

Upon receipt of the retrieval request and retrieval condition from the retrieval instructing/displaying mechanism 13 (present in step S11), the main control part 12 analyzes the contents of the retrieval request and retrieval condition accepted to instruct the retrieval part 14 to perform retrieval based on the retrieval condition. At this time, the specification of a database is performed. The retrieval part 14 searches a table of the specified database in the data storage means 10 (step S12). In the embodiment, a database holding the purchase history table 102 is connected and searched. As a result of searching, IDs “1”, “2” and “3” of customers who bought a bag are extracted from the purchase history table 102 shown in FIG. 3. Then the retrieval part 14 handles these IDs as a set of retrieval results (as a customer ID list) to send the same to the main control part 12.

The main control part 12 stores in the buffer 16 the customer ID list sent from the retrieval part 14 and data on the number of customers specified from the customer ID list (step S13), while it presents the data on the number of customers and the customer ID list on a display, not shown, through the retrieval instructing/displaying mechanism 13 (step S14).

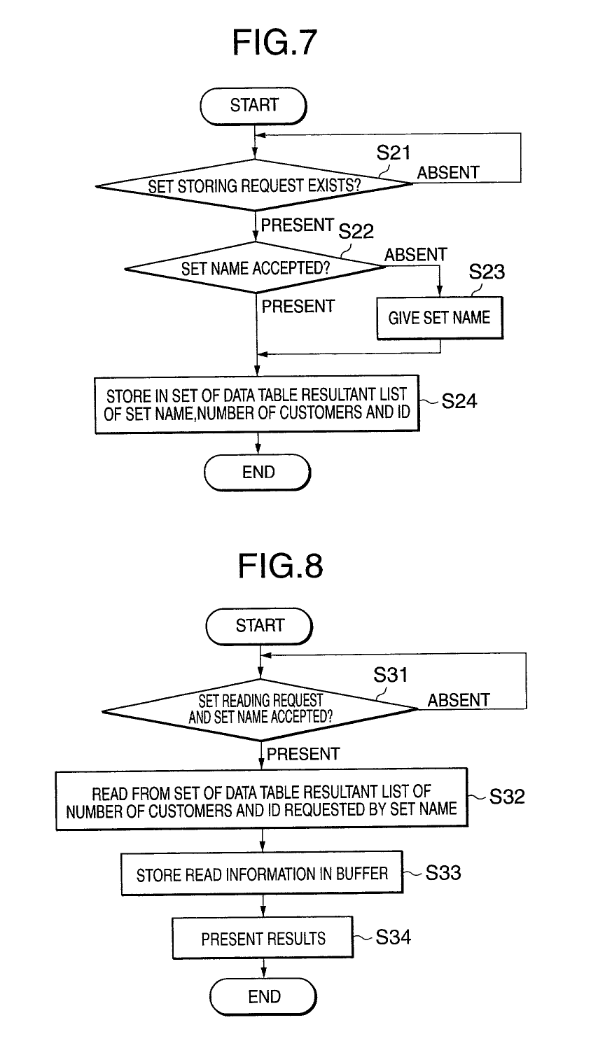

Thus a sequence of processing related to the retrieval is completed.

<Storage into Collection Storage Part: FIG. 7>

FIG. 7 shows a processing procedure related to the storage of the data on the number of customers and the customer ID list into the collection storage part 11 as the retrieval results. The data on the number of customers and the customer ID list to be stored are stored in the buffer 16 of the main control part 12 by performing the processing steps shown in FIG. 6.

Upon receipt of a storage request for the data on the number of customers and the customer ID list stored in the buffer 16 through the retrieval instructing/displaying mechanism 13 (present in step S21), and a set name to be given to the data on the number of customers and the customer ID list (present in step S22), the main control part 12 sends the set of data management part 15 the data on the number of customers and the customer ID list stored in the buffer together with the set name received. The set of data management part 15 gives the received set name to the data on the number of customers and the customer ID list to store the same in the set of data table 111 (step S24).

When receiving the data on the number of customers and the customer ID list but not receiving the set name to be given to the data on the number of customers and the customer ID list to be stored (present in step S21 and absent in step S22), the main control part 12 automatically gives a set name so that the data on the number of customers and the customer ID list are uniquely determined in the system (step S23). The set name enables an identification of a corresponding set stored in the set of data table 111.

The set of data management part 15 checks to be sure that the set name is not identical to any of the set names of already stored, and stores the same in an unused portion of the set of data table 111. If the set name accepted is identical to any of the set names already stored, the main control unit 12 urges the operator to reenter another set name, for example, by making a screen displayed on a display, not shown, so that the operator will be urged to reenter another set name, or automatically give a set name in the same manner as in the case where no set name is given.

<Reading of Customer ID List: FIG. 8>

FIG. 8 shows a processing procedure related to the reading of the customer ID list stored in the set of data table 111 of the collection storage part 11. It is assumed here that customer ID lists as shown in FIG. 4 are stored in the set of data table 111.

In the data management system 1, the retrieval instructing/displaying mechanism 13 accepts a request from the outside for reading a set stored in the set of data table 111 (step S31). Here, since the set of “customers who bought a bag” is to be read, the set name of “customers who bought a bag” is also accepted together with the reading request.

Upon receipt of the set reading request from the retrieval instructing/displaying mechanism 13 (present in step S31), the main control part 12 instructs the set of data management part 15 to read a collection to which the set name requested is given. The set of data management part 15 reads data on the number of customers and customer ID list corresponding to the set name instructed (step S32) to send the main control part 12 the data on the number of customers and customer ID list read-out.

The main control part 12 stores in the buffer 16 the data on the number of customers and customer ID list sent from the set of data management part 15 (step S33), while it presents the data on the number of customers and customer ID list obtained, through the retrieval instructing/displaying mechanism 13.

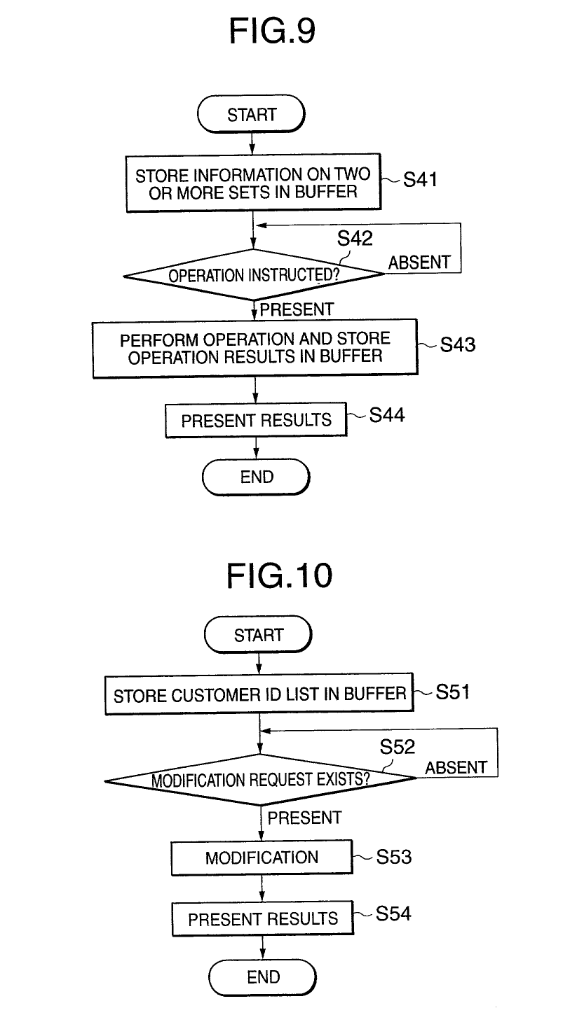

Thus a sequence of processing related to the reading of retrieval results is completed.

<Logical Operation between Customer ID Lists: FIG. 9>

In the embodiment, since each of the customer ID lists is a set of retrieval results, a logical operation, such as logical add (OR), logical product (AND), complementary set and exclusive-OR, with another customer list can be performed. The customer ID list is specified by designating the set name. Suppose here that customers contained in both sets of “customers who bought a bag” and “customers who purchased 50,000 yen or more goods” are to be determined. In this case, the logical product of both customer lists of “customers who bought a bag” and “customers who purchased 50,000 yen or more goods” can be operated to obtain customer IDs contained in both customer ID lists as a result of the logical operation.

FIG. 9 shows a processing procedure of the logical operation.

In the data management system 1, two or more customer ID lists are prestored in the buffer 16 of the main control part 12 (step S41). These customer ID lists are customer lists stored in the set of data table 111 or customer ID lists created by the retrieval part 14 performing retrieval based on the IDs.

Then, when a request for performing an operation between customer ID lists is inputted from the outside through the retrieval instructing/displaying mechanism 13, that is, when the operation instruction for obtaining customers contained in both sets of “customers who bought a bag” and “customers who purchased 50,000 yen or more goods” is inputted (present in step S42), the operation between the customer ID lists stored in the buffer 16 is performed on the basis of the operation request. In this case, since the logical product of both sets is to be determined, customers IDs contained in both of the customers ID lists are selected, and the customer IDs obtained as result of the operation are stored in the buffer 16 as a new customer ID list (step S43). The operation between customer ID lists are performed in the same manner as a logical operation of sets, such as logical add (OR), logical product (AND), complementary set and exclusive-OR.

The main control part 12 presents newly created data on the number of customers and customer ID list through the retrieval instructing/display mechanism 13 (step S44). Thus the operation processing between retrieval results is completed, and the retrieval instructing/display mechanism 13 waits for a new instruction.

The data on the number of customers and customer ID list newly obtained are stored according to the flow of processing shown in FIG. 7.

<Modification of Operation Results: FIG. 10>

FIG. 10 shows a modification procedure of the retrieval results or operation results of a customer ID list. For this processing, the customer ID list to be targeted is stored in the buffer 16 (step S51). Then the retrieval instructing/displaying mechanism 13 accepts a customer ID list modification request from the outside (step S52). The customer ID list to be modified or revised is specified by the set name.

Upon receipt of the modification request (present in step 52), the main control part 12 modifies the customer ID lists stored in the buffer 16 on the basis of the modification request (step S53).

The modification request may include deletion or addition of a customer ID or IDs existing in the customer ID list. Then the main control part 12 presents modified data on the number of customer IDs (namely the number of customers) and customer ID list through the retrieval instructing/displaying mechanism 13 (step S54).

Then, when instructed to store the modified customer ID list through the retrieval instructing/displaying mechanism 13, the main control part 12 overwrites the set table 111 with the modified customer ID list by the same set name, or stores the modified customer ID list by another set name. If the modified customer ID list is stored by another set name, the flow of processing shown in FIG. 7 will be performed.

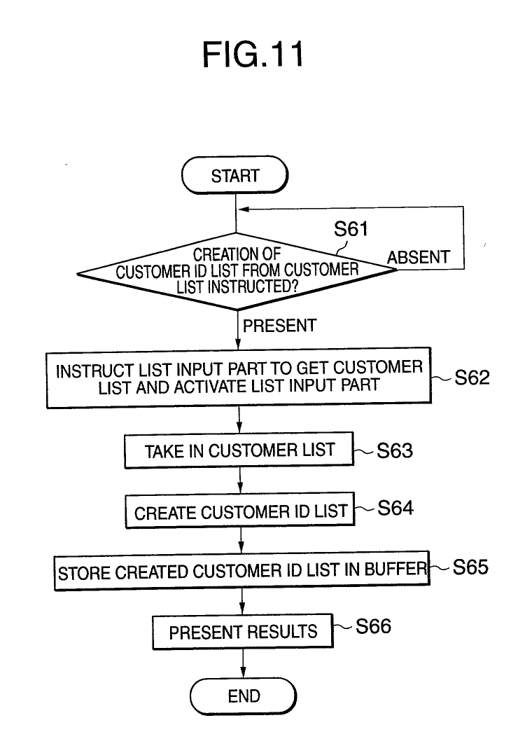

Thus a sequence of processing related to modification of retrieval results is completed, and the retrieval instructing/displaying mechanism 13 waits for a new instruction.

<Creation of Customer ID list: FIG. 11>

FIG. 11 shows a procedure by which a customer ID list is created from the customer list 171 taken in from the list input part 17.

The retrieval instructing/displaying mechanism 13 accepts a customer ID list creation instruction based on the customer list 171 (present in step S61). The customer ID list creation instruction includes information on the storage area in which the customer list 171 as the source of creation of a customer ID list is stored.

Upon receipt of the customer ID list creation instruction, the main control part 12 notifies the list input part 17 of the storage area in which the customer list 171 as the creation source is stored, and activates the list input part 17 (step S62).

The list input part 17 takes in the customer list 171 from the storage area instructed (step S63) to extract customer IDs from the customer list 171 taken in. Then the list input part 17 creates a customer ID list from the customer IDs extracted (step S64). The customer ID list thus created is sent to the main control part 12 together with data on the number of customers.

The main control part 12 stores in the buffer 16 the data on the number of customers and customer ID list sent from the list input part 17 (step S65). For example, if the customer list 171 is a list as shown in FIG. 5, the IDs contained in the customer ID list are “1”, “3” and “10” and the number of customers is “3”.

The main control part 12 presents the customer ID list and data on the number of customers stored in the buffer 16 through the retrieval instructing/displaying mechanism 13 (step S66).

Thus a sequence of processing steps related to the input of the customer list 171 from the outside is completed.

Processing using in combination the basic operations of creation, storage, computation and modification of an ID set or sets, and of the input of a list from the outside displays the following effects:

Effects of Storage of Set

IDs as a result of retrieval are stored as a set (as a customer ID list), so that when retrieval results based on the same retrieval condition is expected again, the retrieval results can be presented at a higher speed than those obtained by re-retrieval. Further, the customer ID list has only to be read from the set of data table 111, which can reduce resources to present the retrieval results.

The purchase history table 102 stores therein data on customer's purchase history. In the above-mentioned embodiment, the purchase history table 102 holds 5 items of data per event as shown in FIG. 3. Assuming that the data length of each item is 10 bytes, the amount of data per event becomes 50 bytes. For example, if 100 customers bought the goods “bag”, the total amount of data is 50 bytes×100=5,000 bytes. On the other hand, if “customers who bought the bag” are retrieved and stored as a set, where it is assumed that the data size of the set name is 20 bytes, the data size of the number of customers is 4 bytes, and the data size of the customer ID list is 4 bytes, the total amount of data is just 20 bytes+4 bytes+4 bytes×100=424 bytes.

In other words, the amount of data when stored as a set is only one-tenth or less of the amount of data when managed in the purchase history table 102. Once the “customers who bought the bag” are stored as a set, the same retrieval does not need performing again. Therefore, these data can be deleted from the purchase history table 102. Since unnecessary data can be deleted, the storage area necessary for storage of data can be remarkably reduced.

Further, when retrieval results or operation results of sets are stored as a new set, a set name is given. It is borne in mind that the set name should be a name indicative of what the customer ID list means, not how the customer ID list (set) was created. The effect of the set name is brought to the fore when logical operations between sets are repeated. This is because even if the conditional expression upon which the set was created is shown, it would be beyond operator's grasp.

Effects of Operation between Sets

Logical operations using in combination the customer ID lists stored and customer ID lists obtained by retrieval can be made available, and therefore, basic operations have only to be repeated until a final customer ID list is obtained. Therefore, a complicated combination of retrieval conditions does not need making at a time, which eliminates the need to acquire a mastery of complicated retrieval requests and reduces the application of load to the retrieval processing system.

Further, the customer ID list is created by searching different databases, respectively. In this case, it is not so difficult to access each database separately so as to obtain the each search result. Then operations between customer ID lists obtained by searching the different databases are performed, which can achieve the same result as compound retrieval which logically handles different databases as one database.

Effects of Modification of Customer ID List

The customer ID list is made modifiable, which makes it possible to customize the customer ID list as intended by the operator who is making a modification or modifications. Thus the operator can customize the customer list for his or her convenience.

As long as there is an item in each table of the data storage means 10, it can be retrieved to create a desired customer ID list. Even if there is no item to be retrieved, the customer ID list can be modified to create a desired customer ID list.

Suppose that the operator selects “executive director's important clients.”

In this case, selection criteria are so ambiguous and variable from person to person (from company to company) that the executive director may not clearly tell how important a client is. It is therefore difficult to obtain a desired customer ID through searching tables.

However, some client IDs may be extracted in advance, for example, on the basis of rough retrieval conditions, and grouped as a set, so that the executive director can check the names one by one, (for each company) to determine the degree of importance. As a result, IDs can be added or deleted to create the optimum set of IDs.

Once a set of IDs of “executive director's important clients” is registered, the set can be processed from then on in the same manner as the set created by certain retrieval conditions. Even if the contents of “executive director's important clients” vary during one year between 1999 and 2000, it can respond to the variations.

Effects of Creation of Customer ID List from Customer List

Any set can be created from the customer list 171 that has already been created outside the data management system 1 using a spreadsheet application or the like, which makes it possible to perform an operation of a set of customers contained in the customer list 171 and a set from another customer list 171, or create a new set in combination with a condition registered in the database. It should be noted that the set is grouped by attributing importance to what the customer list 171 means (what kind of customers belong to the set), not to under what condition the customer list 171 was created. Even in the case that no customer can be retrieved and selected on the basis of any item registered in the database, any set can be manually created outside the system to create a set of desired IDs.

Further, the creation of a set by taking in the customer list 171 from the outside results in a supplement to part of the function for searching multiple databases and creating a set.

For example, when one database of a data management system provided with no connection interface needs to be searched, the database concerned is searched from the other data management system provided with a connection interface. Then a customer ID list obtained as a result of the search is inputted as a customer list 171 to the one data management system provided with no connection interface. The one data management system takes in the customer ID list from the other data management system provided with the connection interface, which is considered to correspond to, though indirectly, searching the database concerned. Since the function for outputting the retrieval results is normally provided with any data management system, the retrieval results can be obtained from any database even with a special interface as long as the system has the function for taking in a list from the outside and creating a set like the list input part 17.

The present invention is not limited to management of customer's purchase history, and it is applicable to the following fields:

In addition to a history of customer's goods purchase, various transactions with customers, such as a history of customer inquiries over the phone, via faxes, mails, e-mails and the like can be dealt with.

Data exemplified in the customer table 101 and the purchase history table 102 are not limited to those stored in a database or databases, and they can be stored in data warehouses, data marts, data Web-houses and the like.

Any history can be downloaded to and stored in a site or page on the Internet in the same manner as the purchase history so that it will be made available. Data retrieved on the Internet can also be stored as a set so that the set will be reused.

The embodiment illustrated such a case that data to be retrieved were stored in and retrieved from two tables, the data to be retrieved are not limited to the case. The data may be stored in any form as long as they are identifiable by identification information.

The data management system according to the present invention can also be realized by executing a computer program according to the present invention on a computer. In such an embodiment, the computer program is recorded on a recording medium, such as a disk device or semiconductor memory, capable of being accessed by the computer (the term “access” means recording and reading, which is the same below), so that the computer program cooperates with a control program (such as an OS) installed in the computer to form functional blocks corresponding to the data storage means 10, the collection storage part 11, the main control unit 12, the retrieval instructing/displaying mechanism 13, the retrieval part 14, the set of data management part 15 and the list input part 17.

As described above and according to the present invention, a list created outside the data management system is held as a set, which makes it easy to compare sets or compare the set with data in the data storage mechanism. Even if data are stored in multiple data storage mechanisms, compound retrieval of data across the multiple data storage mechanisms can be easily performed.

Additional advantages and modifications will readily occur to those skilled in the art. Therefore, the invention in its broader aspects is not limited to the specific details and representative embodiment shown and described herein. Accordingly, various modifications may be made without departing from the spirit or scope of the general inventive concept as defined by the appended claims and their equivalents.

What is claimed is:

1. A data management system comprising:
acceptance means for accepting various retrieval conditions for data storage means in which data belonging to any of multiple managed objects are stored;
retrieval means for retrieving data adapted to each of the accepted retrieval conditions from the data storage means and specifying a managed object to which the retrieved data belong; and
holding means for holding identification information for identifying the managed object specified by said retrieval means as part of a collection of retrieval results collected for each retrieval condition,
wherein the collection held in said holding means is set as a target of retrieval instead of said data storage means.

2. The data management system according to claim 1, further comprising external data taking-in means for taking in data created in an external system and containing identification information on the managed object to add the identification information contained in the taken-in data as part of a corresponding collection.

3. The data management system according to claim 2, wherein said external data taking-in means is configured to take in the data created in the external system in the form of a list for each managed object to add the identification information to the collection on a list basis.

4. The data management system according to claim 1, further comprising computation means for performing a logical operation between two or more collections to create a new collection so as to make said holding means hold the newly created collection.

5. The data management system according to claim 4, wherein said holding means includes temporary storage means for temporarily storing the collections before held therein, such that said computation means performs the logical operation between the collections stored in said temporary storage means while storing the new collection in said temporary storage means.

6. The data management system according to claim 5, further comprising modification means for modifying the collections stored in said temporary storage means.

7. A data management system comprising:
acceptance means for accepting various retrieval conditions for a plurality of data storage means in which plural kinds of customer data identifiable by each ID are distributively stored;
retrieval means for retrieving data adapted to each of the accepted retrieval conditions from any one of said data storage means and specifying a customer ID of the data retrieved;
holding means for holding the ID specified by said retrieval means as part of a collection of retrieval results collected for each retrieval condition; and
means for taking in customer-related data created in an external system and containing the ID to add the ID contained in the taken-in data as part of the collection held in said holding means,
wherein the collection held in said holding means is set as a target of retrieval instead of said plurality of data storage means.

8. The data management system according to claim 7, further comprising computation means for performing a logical operation between two or more collections to create a new collection so as to make said holding means hold the newly created collection.

9. A computer-based data management method implemented on a computer connected to data storage means in which data belonging to any of multiple managed objects are stored, the data management method comprising the steps of:
accepting various retrieval conditions;
retrieving data adapted to each of the accepted retrieval conditions from said data storage means and specifying a managed object to which the retrieved data belong; and
holding identification information for identifying the specified managed object in certain holding means as part of a collection of retrieval results collected for each retrieval condition,
wherein the collection held in said holding means is set as a target of retrieval instead of said data storage means.

10. A computer program which enables data retrieval on a computer connected to data storage means in which data belonging to any of multiple managed objects are stored, the computer program comprising the steps of:
accepting various retrieval conditions;
retrieving data adapted to each of the accepted retrieval conditions from said data storage means and specifying a managed object to which the retrieved data belong; and
holding identification information for identifying the specified managed object in certain holding means as part of a collection of retrieval results collected for each retrieval condition,
wherein the collection held in said holding means is set as a target of retrieval instead of said data storage means.
